(19) United States
(12) Patent Application Publication
(10) Pub. No.: US 2026/0087886 A1
(43) Pub. Date: Mar. 26, 2026

(54) ELECTRONIC GAMING SYSTEMS INCLUDING PICK BONUS GAMES FOR BASE GAME MATRIX SELECTION

(71) Applicant: Aristocrat Technologies, Inc., Las Vegas, NV (US)

(72) Inventors: Sara LaRocca, Reno, NV (US); Jennifer Mizzi, Ewa Beach, HI (US); Rogelio Decasa, JR., Renton, WA (US); Nathan Warms, Austin, TX (US); Nicholas Farina, Granger, IN (US); Zachary Smith, Austin, TX (US); Hanna Sanborn, Georgetown, TX (US); Carlyn Albright, Reno, NV (US); Kelly Lockheed, Elkridge, MD (US)

(21) Appl. No.: 18/891,872

(22) Filed: Sep. 20, 2024

(51) Int. Cl. G07F 17/32

(52) U.S. Cl. CPC G07F 17/3267; G07F 17/3213

(57) ABSTRACT

An electronic gaming system includes a game controller in communication with at least one memory. The game controller includes at least one processor, that is configured to cause to be displayed on a display device a hold-and-spin game triggered by an outcome of a base reel game. The hold-and-spin game and the base reel game include a plurality of expandable reels. The processor(s) is also configured to determine that an outcome of the hold-and-spin game triggers a bonus wheel game, where the bonus wheel game includes a plurality of rotatable bonus wheels. Additionally, the processor(s) is configured to cause to be displayed on the display device a pick bonus game, the pick bonus game including a plurality of selectable pick game symbols. Each of the plurality of selectable pick game symbols are associated with a base reel game matrix for the plurality of expandable reels.

### TECHNICAL FIELD

The field of disclosure relates generally to electronic gaming, and more specifically, to electronic gaming systems, programs, and methods that include presenting pick bonus games in which a user selects an improved base reel game matrix for subsequent base reel games.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Notably, some games may include an element of skill on the part of the player and are therefore not entirely random.

### BRIEF DESCRIPTION

In one aspect, an electronic gaming system includes at least one memory for storing instructions; and a game controller in communication with the at least one memory, the game controller including at least one processor, when the instructions are executed by the at least one processor, the at least one processor configured to: cause to be displayed on a display device a hold-and-spin game triggered by an outcome of a base reel game, the hold-and-spin game and the base reel game including a plurality of expandable reels; determine that an outcome of the hold-and-spin game triggers a bonus wheel game, the bonus wheel game including a plurality of rotatable bonus wheels; and in response to the bonus wheel game concluding, cause to be displayed on the display device a pick bonus game, the pick bonus game including a plurality of selectable pick game symbols, wherein each of the plurality of selectable pick game symbols are associated with a base reel game matrix for the plurality of expandable reels.

In another aspect, a method of electronic gaming implemented on an electronic gaming machine includes causing to be displayed on a display device a hold-and-spin game triggered by an outcome of a base reel game, the hold-and-spin game and the base reel game including a plurality of expandable reels; determining that an outcome of the hold-and-spin game triggers a bonus wheel game, the bonus wheel game including a plurality of rotatable bonus wheels; and in response to the bonus wheel game concluding, causing to be displayed on the display device a pick bonus game, the pick bonus game including a plurality of selectable pick game symbols, wherein each of the plurality of selectable pick game symbols are associated with a base reel game matrix for the plurality of expandable reels.

In an additional aspect, a non-transitory computer-readable storage medium with instructions stored thereon is provided. The instructions, in response to execution by at least one processor, cause the at least one processor to: cause to be displayed on a display device a hold-and-spin game triggered by an outcome of a base reel game, the hold-and-spin game and the base reel game including a plurality of expandable reels; determine that an outcome of the hold-and-spin game triggers a bonus wheel game, the bonus wheel game including a plurality of rotatable bonus wheels; and in response to the bonus wheel game concluding, cause to be displayed on the display device a pick bonus game, the pick bonus game including a plurality of selectable pick game symbols, wherein each of the plurality of selectable pick game symbols are associated with a base reel game matrix for the plurality of expandable reels.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4A and 4B are example user interfaces or screenshots of a sequence of a base reel game for an example electronic game in accordance with the present disclosure.

FIGS. 5A-5E are example user interfaces or screenshots of a sequence of a triggered hold-and-spin bonus game of an example electronic game, in accordance with the present disclosure.

FIG. 6 is an example user interface or screenshot of a base reel game after the hold-and-spin bonus game of FIGS. 5A-5E ends, in accordance with the present disclosure.

FIG. 7 is an example user interface or screenshot of another implementation of the hold-and-spin bonus game for the example electronic game, in accordance with the present disclosure.

FIGS. 8A-8E are example user interfaces or screenshots of a sequence of a triggered bonus wheel game for the example electronic game in accordance with the present disclosure.

FIGS. 9A-9D are example user interfaces or screenshots of a sequence of a triggered pick bonus game and the transition to the base reel game for the example electronic game in accordance with the present disclosure.

### DETAILED DESCRIPTION

In some known electronic gaming systems, awards and/or outcomes of a primary game may be presented to a player as awards and/or outcomes of a secondary game. For example, an electronic gaming device may present a game outcome as a reel game (e.g., a slot game) simulation. For example, an award value associated with a game outcome may be presented in the simulated reel game outcome as a symbol combination and/or one or more special symbols that correspond to the same award value. In some known games, the award value of the game outcome may be partitioned or distributed across a base reel game outcome and one or more bonus game outcomes (e.g., outcomes of one or more free reel or wheel spins). For example, an award value associated with one or more winning bingo patterns may be presented as being awarded in a base reel game outcome and one or more bonus game outcomes. While some variations exist for presenting the game outcomes across the base reel game outcome and/or the one or more bonus game outcomes exist, the variability and flexibility in presenting these outcomes remain limited. A need exists to address these limitations, while also improving on machine performance, memory storage and the overall functioning of the networked system controlling the gaming devices.

Embodiments of the present disclosure provide systems, program products, and methods for displaying base reel game outcomes that may include a triggering of one or more bonus or auxiliary games, or alternatively displaying bonus games to the player. The bonus games described herein include a hold-and-spin game, a bonus wheel game, and a pick bonus game, respectively. The bonus games provide players with a fast-paced animation and the displaying of (potentially) multiple awards or credit values. Additionally, interactive bonus games allow the player to interact with the gaming machine to attempt to win additional awards and credit values during the game. Furthermore, each bonus game can include the ability for the player to play both the bonus game, as well as be presented bonus game features - each awarding additional credit values. Additionally with respect to the hold-and-spin game, credit values (e.g., cash-on-reel values) revealed on game reels during the game can be persistent and/or be continuously displayed during subsequent instances of the hold-and-spin game. Furthermore, and with respect to the pick bonus game, the player can control the matrix or arrangement of the reels included in the base reel game prior to subsequent plays by selecting a predetermined reel matrix. The persistence of the credit values that potentially carry over through multiple hold-and-spin games, as well as providing the player the ability to select the matrix arrangement for the reels of the base reel game during the pick bonus game, provide an improved electronic game by increasing the variability and flexibility in presenting winning outcomes of the bonus game (e.g., winning symbol combinations and/or special symbols) to the player while maintaining a level or reducing the level of memory and/or computational resources needed to provide these enhancements.

The persistency of a credit value through the hold-and-spin game may include, for example, continuously displaying a revealed cash-on-reel credit value within the hold-and-spin game. Where a credit value is displayed in the hold-and-spin game, that credit value can be continuously presented to the player during the remainder of spins for the hold-and-spin game. The persistent credit values that remain displayed during the hold-and-spin game potentially increase the credit values a player can win, while also increasing the variability of the game including the various bonus games. This persistence in the credit values during the hold-and-spin game in turn can also improve control and assurance of RTP during the gameplay. Additionally, and to improve technical issues commonly experienced during game plays, persistence in the credit values over multiple displays of the hold-and-spin game can also reduce the amount of memory required by the gameplay and/or reduce the computational resources needed to operate the game.

Similarly, the ability for the player to predetermine and/or preselect the matrix arrangement for the plurality of reels included in the base reel game during a pick bonus game also can potentially increase the credit values a player can win, while increasing the variability of the game. The selection of the matrix arrangement for the reels during subsequent base reel games in turn can also improve control and assurance of RTP during the gameplay. Furthermore, selection of the reel matrix for subsequent base reel games can reduce the computational resources needed to operate the game and/or reduce the amount of memory required by the gameplay.

The example systems, program products, and methods of the present disclosure represent a technical improvement in the field of electronic gaming. Technical improvements represented by the present disclosure include: (i) presenting Class II and Class III game outcomes as one or more outcomes of a bonus game and/or bonus features; (ii) providing credit values to persist and/or be continuously displayed and in turn awarded during a hold-and-spin game; (iii) utilizing multiple bonus games to provide additional gameplay features/winning opportunities during gameplay; (iv) increasing the flexibility and variability in presenting award values of a game outcome as one or more bonus game outcomes; (v) providing players the opportunity to actively participate during the bonus games; (vi) displaying immediate bonus game feedback to a player; (vii) maintaining/reducing the amount of memory needed to carry out the improved variability of the gameplay as a result of persistent credit values and/or selecting reel matrices for subsequent base reel games; (viii) reducing the computational resources needed as a result of (a) the persistent credit values that remain displayed during hold-and-spin games, and (b) defining reel matrices for base reel games during pick bonus games and prior to playing the base reel; and/or (ix) improved control and assurance of RTP by enabling control of the credit awards through the persistent credit values in the hold-and-spin game and/or defining reel matrices for base reel games during pick bonus games. Additional and/or alternative technical improvements may exist.

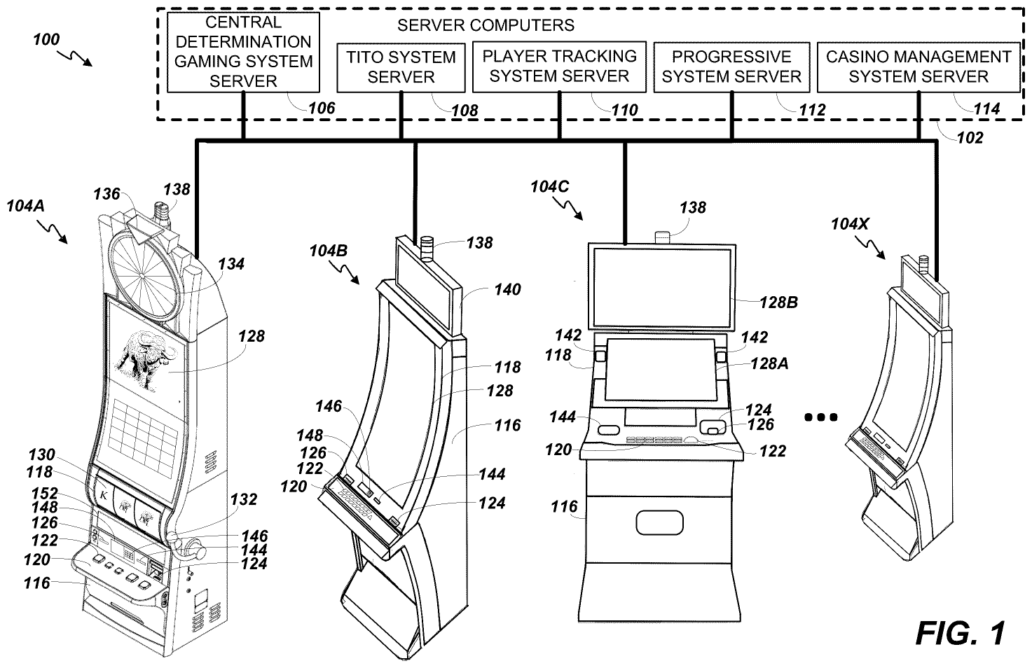

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

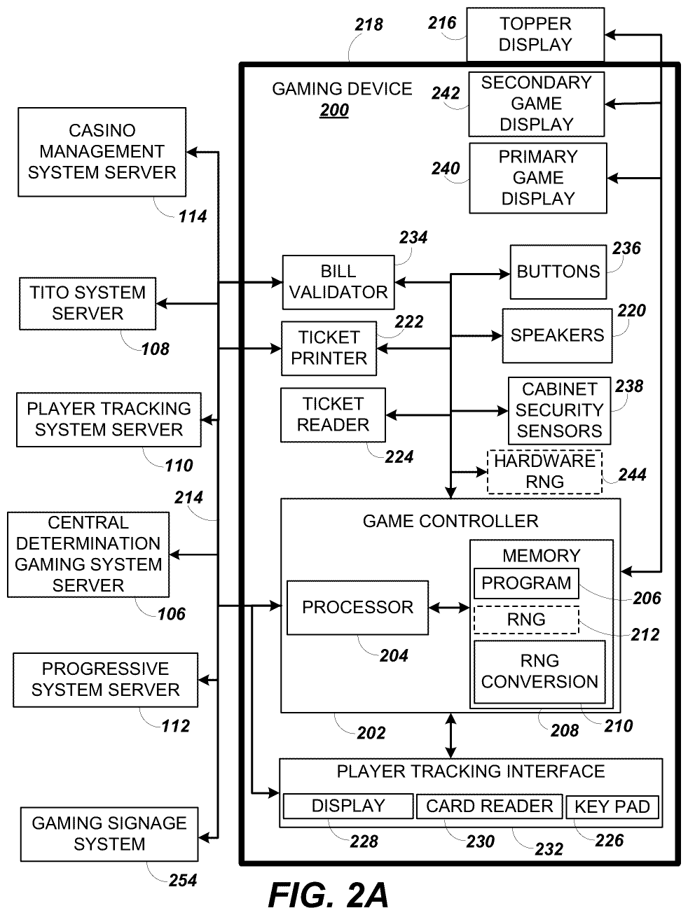

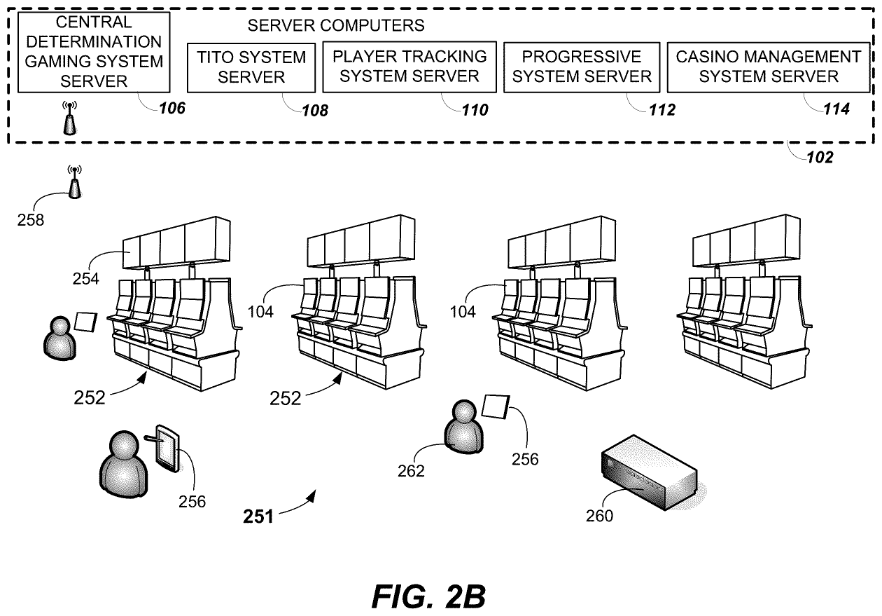

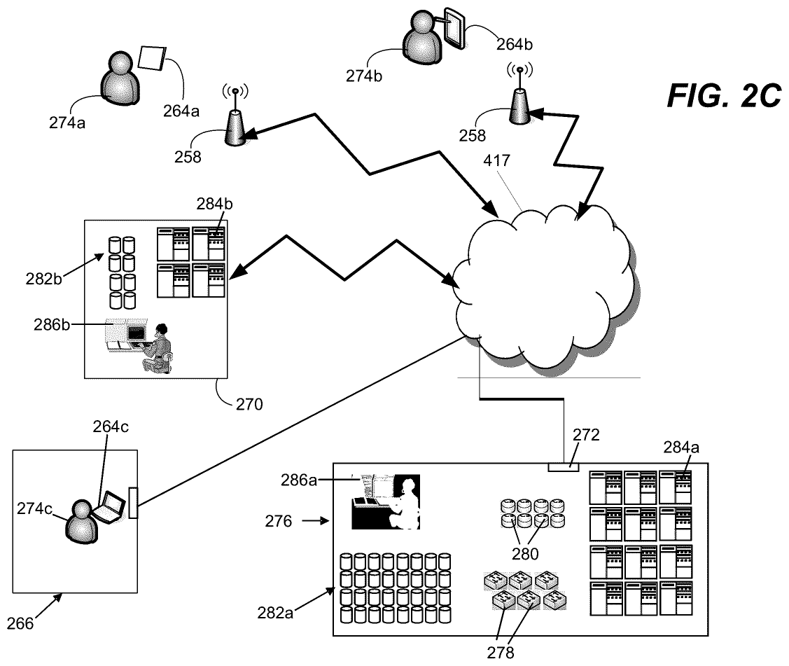

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more Uis, the game outcome on one or more of the primary game displays 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding number of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

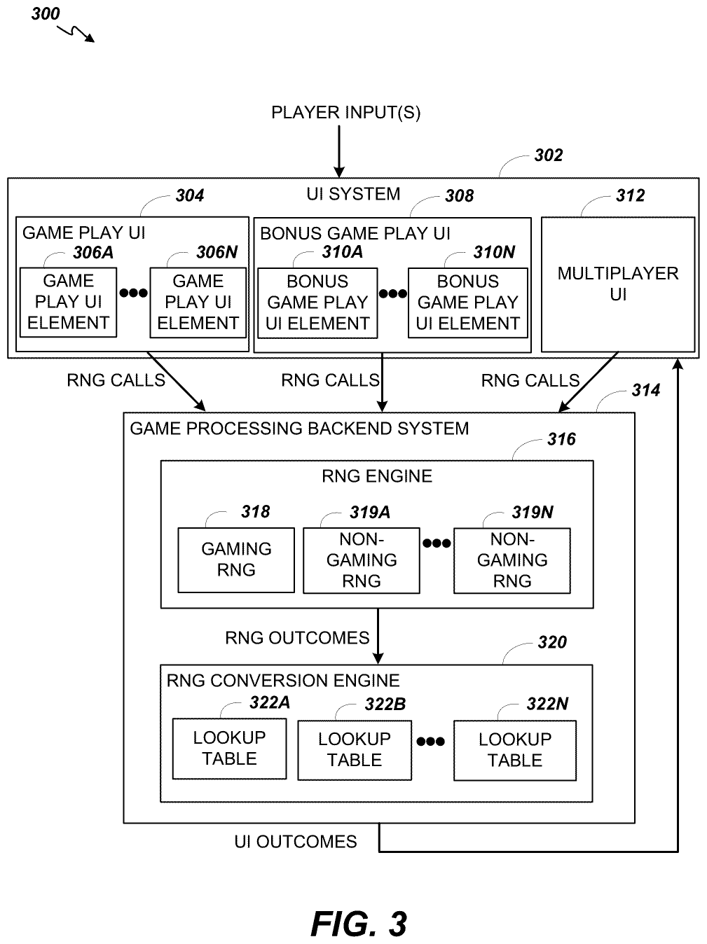

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more Uis that a player can interact with. The UI system 302 could include one or more game play Uis 304, one or more bonus game play Uis 308, and one or more multiplayer Uis 312, where each UI type includes one or more mechanical Uis and/or graphical Uis (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

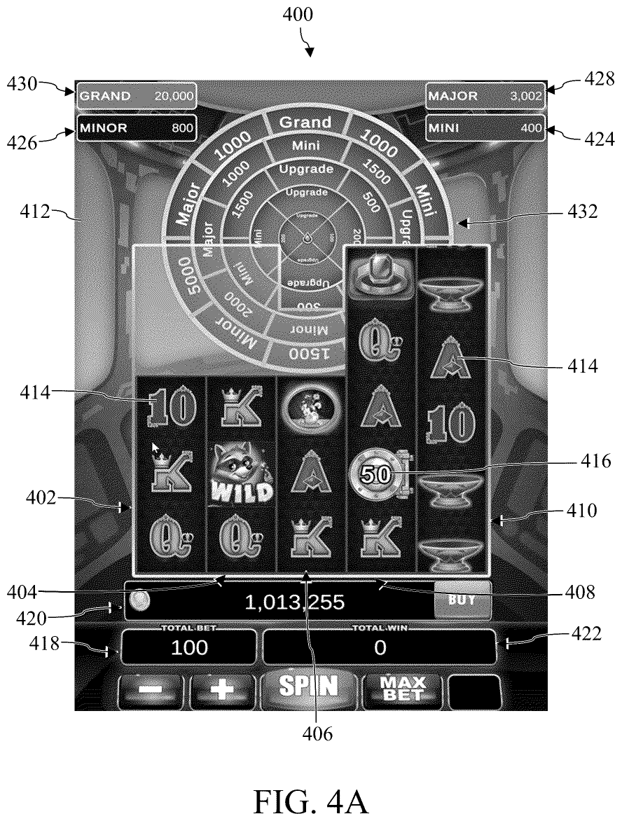

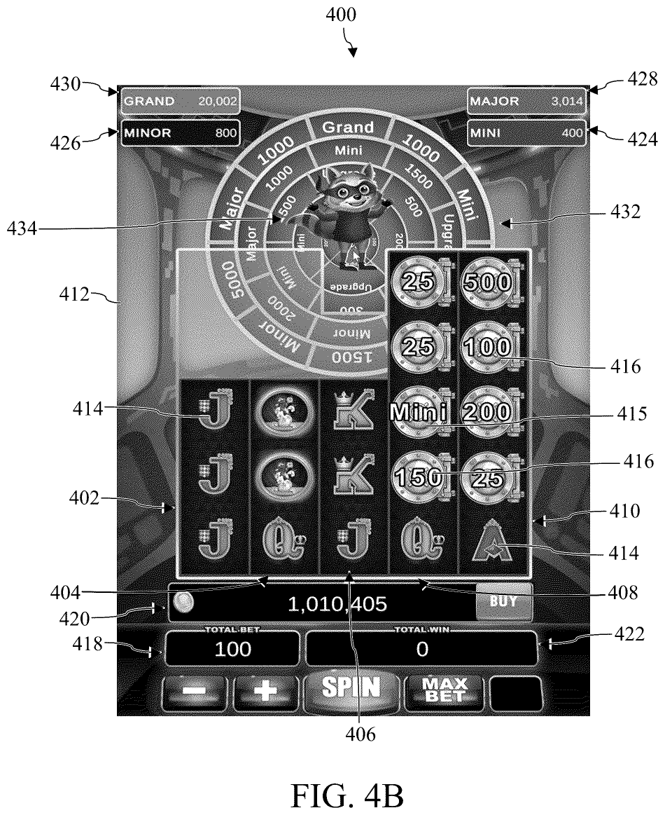

FIGS. 4A and 4B are example user interfaces or screenshots of an example base reel game 400 played on a gaming device (e.g., gaming devices 104A-104X in FIG. 1, and/or gaming device 200 and/or mobile gaming device 256 in FIG. 2). Specifically, FIGS. 4A and 4B show a base reel game 400, in which a base reel game outcome is displayed that corresponds to (e.g., presents, represents, and/or is determined from) an output of the gaming device. The output may be a primary game outcome determined in response to a wager received from a player. In example implementations, the primary game outcome is a Class II (e.g., bingo) game outcome or a Class III or Las-Vegas style game outcome. In various implementations, the base reel game 400 may be implemented to present an outcome of any suitable game of chance. Specific details of the type of primary or base reel game outcomes presented using the base reel game 400 are not central to an understanding of the present disclosure. However, additional detail related to at least one implementation (e.g., an implementation employing the base reel game 400 to present a primary bingo-based or Class II game outcome) may be obtained with reference to U.S. Published Patent Application No. 2012/0270638, filed Apr. 20, 2011, and entitled GAMING MACHINE WITH FREE PLAY BONUS MODE PRESENTING ONLY WINNING OUTCOMES, the disclosure of which is hereby incorporated by reference herein in its entirety.

The base reel game 400 may be initiated on a gaming device 104A-104X and 200. Specifically, a player may fund the base reel game 400 via bill validator 234 and/or ticket reader 224. Once funded, the base reel game 400, which includes a first plurality of reels 402, 404, 406, 408, and/or 410, each including a plurality of game symbols 414, may appear on a display 412. The first plurality of reels 402-410 may be physical reels and/or virtual reels. As used herein, physical reels are mechanical in nature and may be physically rotated during gameplay. In contrast, virtual reels are rendered or visually created by game controller 202 on a display, such as primary game display 240, and are merely animated to give the appearance of being spun. The first plurality of reels 402-410 of the example base reel game 400 include five reels. In other examples, the number of reels may range from one reel to five or more reels in number. The base reel game 400 may be played on display 412. However, in other implementations, the base reel game 400 may be played on several displays including display 412 and an additional or auxiliary displays.

The base reel game 400 may be played on several displays, such as the primary display 412 and a secondary display. However, in other implementations, the base reel game 400 may be played on a single display and/or on greater than two displays. In the example shown in FIGS. 4A and 4B, the base reel game 400 includes a first reel matrix on the primary display 412. The first reel matrix includes a plurality of symbol arrangements or positions arranged in a plurality of rows and a plurality of columns. The first reel matrix may also therefore be referred to as a “matrix of symbol positions” or “matrix of symbol arrangements.” While, in the example shown in FIGS. 4A and 4B, the first reel matrix is displayed on the primary display 412, the first reel matrix may appear in other locations on an EGM 104A-104X and/or on other displays, such as, for example, the secondary display, a display of button deck 120, and the like.

In the example embodiment shown in FIGS. 4A and 4B, the plurality of reels 402-410 form five distinct reels and/or five columns. Each reel 402-410 also includes an expandable number of rows as well. In the exemplary embodiment, reels 402, 404, 406 have three (3) rows, and reels 408, 410 have five (5) rows. As a result, the plurality of reels 402-410 for base reel game 400 include a 3×3×3×5×5 arrangement, as depicted on display 412, and include nineteen (19) game symbol positions. As described herein, the number of expandable rows for each reel 402-410 of base reel game 400 varies based on outcomes and/or gameplay of a hold-and-spin bonus game, and/or selections made during a pick bonus game.

In other implementations, the plurality of reels 402-410 may be any size/uniformity/arrangement (e.g., 2×2, 3×3, 4×4, 10×10, etc.), and a number of game symbol positions for the plurality of reels 402-410 may vary depending upon a number of rows and columns of the plurality of reels 402-410. In some implementations, the plurality of reels 402-410 may be replaced by one or more mechanical reels, and the implementations described herein work equally well with mechanical reels as with the virtual plurality of reels 402-410, as shown in FIGS. 4A and 4B. Each row of the plurality of reels 402-410 may be designated by a row number (e.g., “1,” “2,” “3,” etc.). Each column of the plurality of reels 402-410 may be designated by a column letter (e.g., “A,” “B,” “C,” “D,” “E,” etc.). Each game symbol position of the plurality of reels 402-410 may therefore be designated by a symbol position identifier comprising a row number (e.g., “1,” “2,” “3,” etc.) and a column letter (e.g., “A,” “B,” “C,” “D,” “E,” etc.). For example, the upper-right-most game symbol position, occurring at the intersection of row 1 and column E, may be designated by the game symbol position identifier “1E.” In another example, the bottom most game symbol position for reel 406, occurring at the intersection of row 5 and column C, may be designated by the game symbol position identifier “5C.”

As described herein, during play of the base reel game 400, game symbols 414 may be selected (e.g., such as from the plurality of reels 402-410) and displayed in the game symbol positions of each column and row of the plurality of reels 402-410. Although not central to an understanding of the present disclosure, each of the plurality of reels 402-410 may include a plurality of game symbols 414 arranged in a vertical column. A number of game symbols 414 of each reel 402-410, corresponding to the number of rows of the plurality of reels 402-410, is displayed in a column of game symbol positions within the plurality of reels 402-410 during play of the base reel game 400. To display symbols from a reel within the plurality of reels 402-410, processor 204 may simulate rotation or spinning of one or more of the plurality of reels 402-410 within a respective column of the plurality of reels 402-410. Here again, however, mechanical reels having physical reel strips may be used as well. When a respective reel is simulated to halt or stop within an associated column, one or more game symbols 414 may be displayed from the reel 402-410 in the game symbol positions of the column. The game symbols 414 displayed after spinning and stopping each reel strip in a respective column of the plurality of reels 402-410 may be referred to herein as a “reel outcome” or a “base reel game outcome” or a “base game outcome.” More broadly, an “outcome” of a reel game, such as a base reel game (e.g., the base reel game 400) refers to the game symbols 414 displayed in the plurality of reels 402-410 after reel strips are spun and stopped. Thus, a rotation and stopping of a plurality of reel strips (also referred to herein as a “spin and stop sequence”) may be simulated by processor 204 within the columns of the plurality of reels 402-410 to cause a reel outcome, including a plurality of game symbols 414, to be displayed from the plurality of reel strips within the columns of the plurality of reels 402-410.

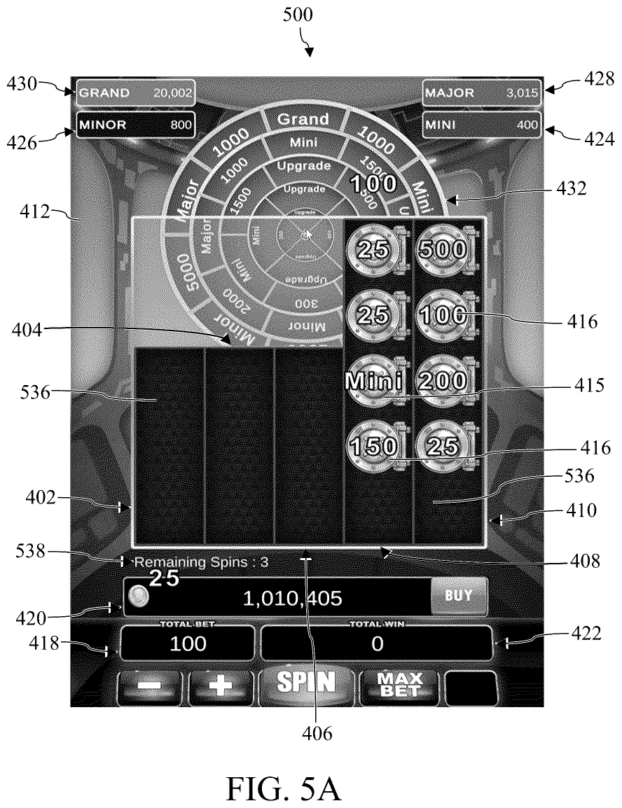

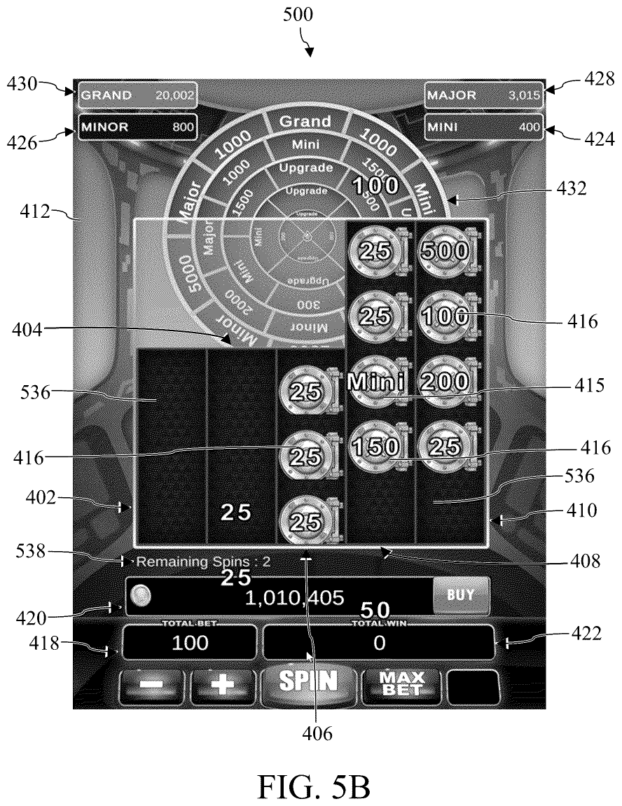

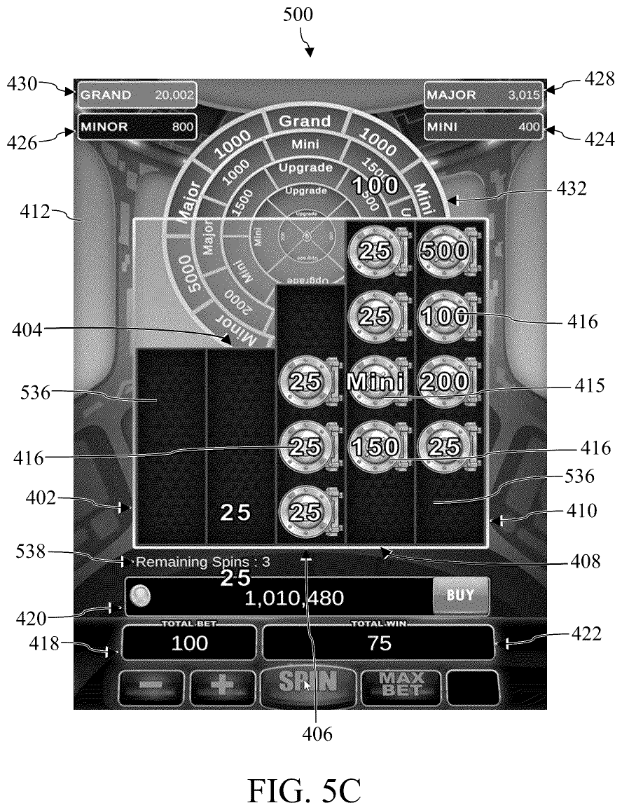

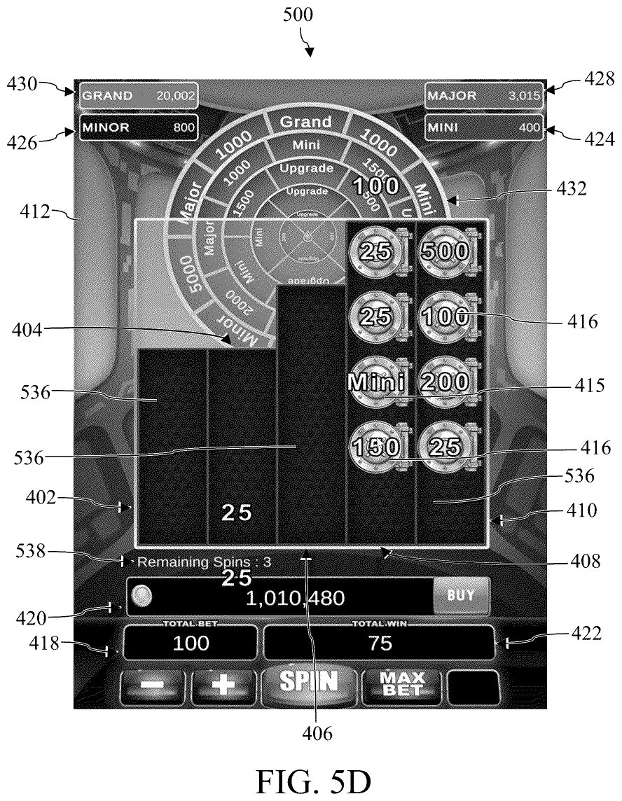

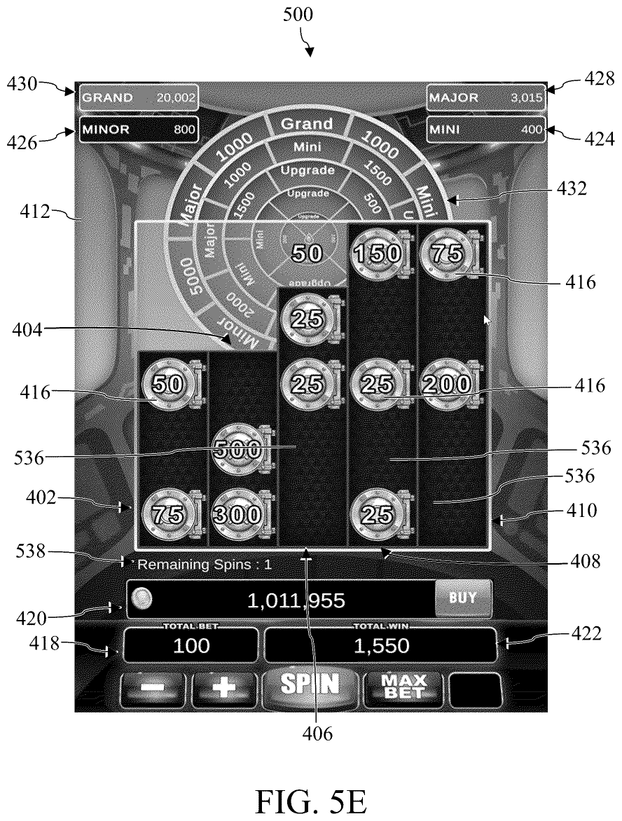

As shown in the exemplary embodiment of FIG. 4A, and as discussed herein, the plurality of game symbols 414 included and/or displayed within the plurality of reels 402-410 include and/or are formed from various symbol types. For example, graphic game symbols of the plurality of game symbols 414 include predetermined graphics, symbols, and/or art works that can be based on a theme, story, and/or visual representation of base reel game 400. Additionally, or alternatively, graphic game symbols include suitable graphics, symbols, and/or artworks commonly associated with gaming device (e.g., “BAR,” “SPIN,” “WILD,” etc.). The plurality of game symbols 414 include jackpot symbols 415, which include, display, depict, and/or are associated with jackpots, as discussed herein. That is, jackpot symbols 415 can provide additional award credits to the player during base reel game 400 and/or can trigger the hold-and-spin bonus game (see, FIGS. 5A-5E), as discussed herein. Additionally, the plurality of game symbols 414 include cash-on-reel (COR) symbols 416 displayed within the plurality of reels 402-410. COR symbols 416 include, display, depict, and/or are associated with a predetermined credit value (e.g., COR credit value) that can provide additional award credits to the player during base reel game 400 and/or can trigger the hold-and-spin bonus game (see, FIGS. 5A-5E), as discussed herein.

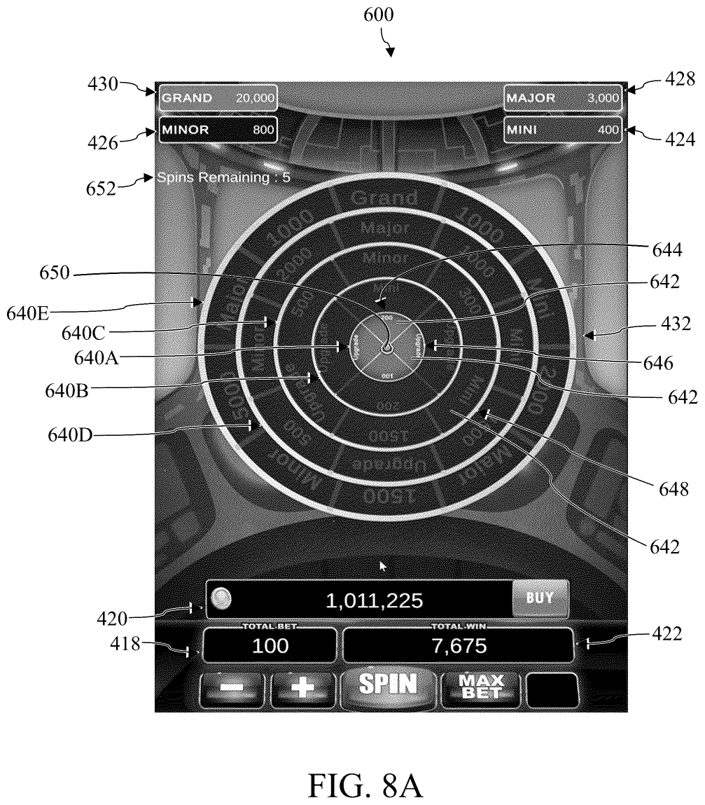

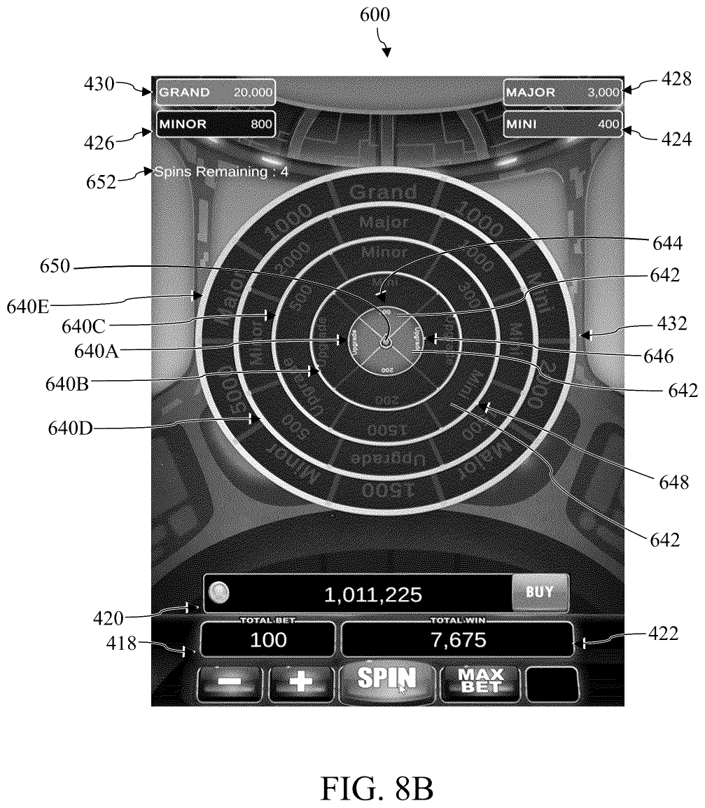

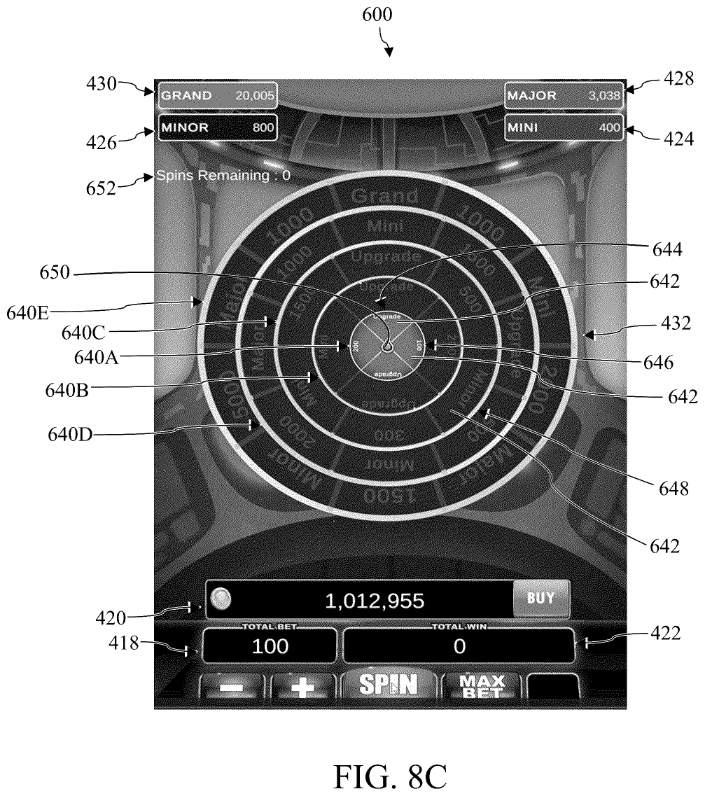

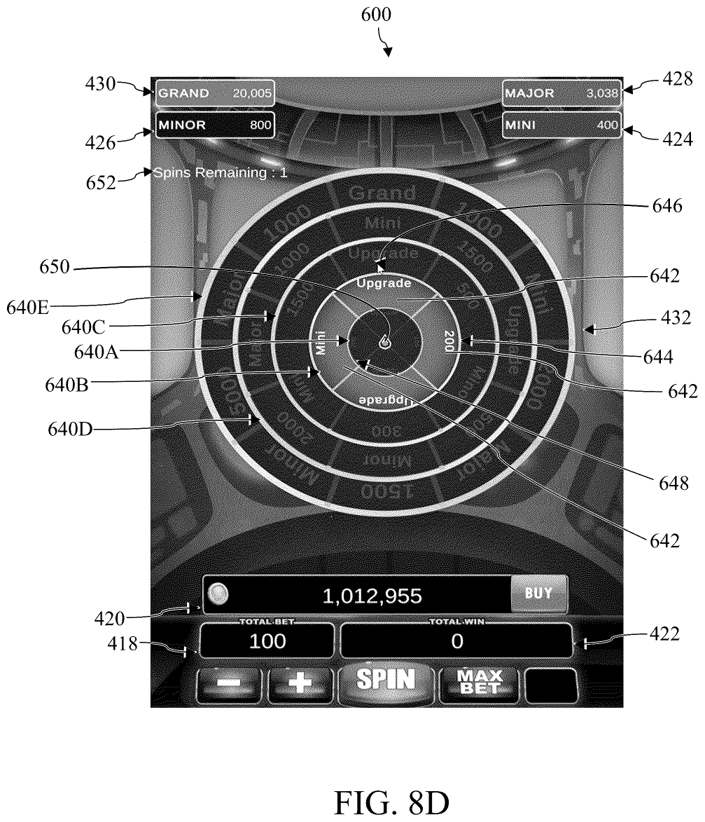

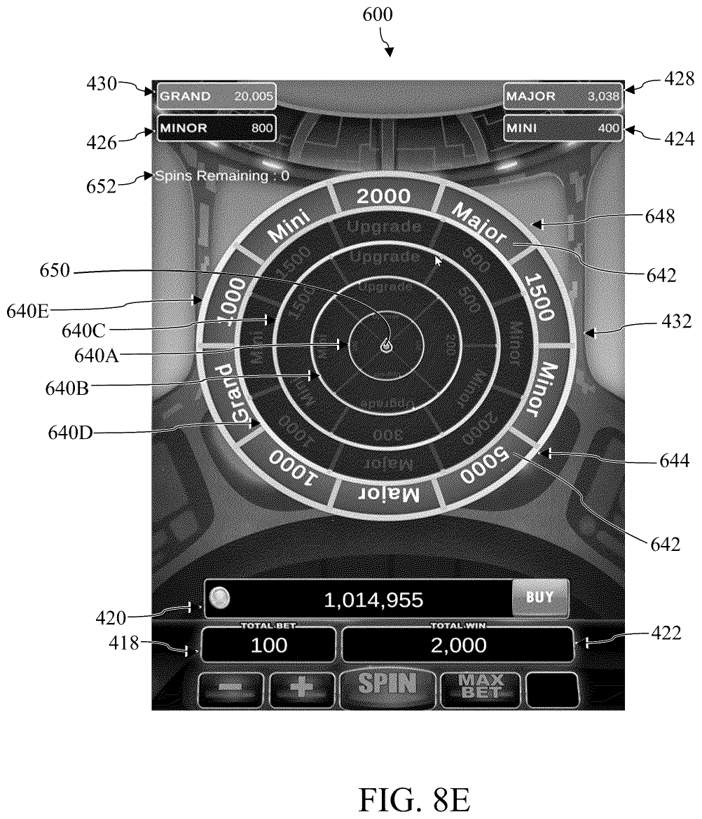

Base reel game 400 also includes a wager meter 418, and a credit meter 420 depicted on display 412. Wager meter 418 represents and/or displays the credit and/or monetary value being wagered during each play of base reel game 400, as determined by the player. Credit meter 420 displays a credit balance (calculated as a sum total of credits input and awards accrued minus wagers placed) accrued until a player cashes out. A win meter 422 is also displayed in base reel game 400. As discussed herein, win meter 422 displays a credit and/or monetary value awarded during outcomes of the base reel game 400, hold-and-spin bonus game (see, FIGS. 5A-5E), and/or a bonus wheel game (see, FIGS. 8A-8E), as discussed herein.

In exemplary embodiments, base reel game 400 also displays a plurality of “jackpot” bonuses 424, 426, 428, 430 on display 412. For example, jackpot bonus 424 includes a “mini” jackpot value, jackpot bonus 426 includes a “minor” jackpot value, jackpot bonus 428 includes a “major” jackpot value, and jackpot bonus 430 includes a “grand” jackpot value. As discussed herein, each jackpot bonus 424-430 can correspond to and/or is correlated with at least one bonus event that is triggered by the base reel game outcome of base reel game 400, a hold-and-spin outcome of a hold-and-spin game, and/or a bonus wheel game outcome for a bonus wheel game. Additionally, the credit value associated with each jackpot bonus 424-430 may be a predetermined credit value. Alternatively, jackpot bonuses 424-430 include progressive credit values that are dependent upon, at least in part, the credit and/or monetary value being wagered during each play of base reel game 400 (e.g., wager meter 418), the number of consecutive base reel games 400 played prior to triggering hold-and-spin games/bonus wheel games, and the like.

As shown in FIGS. 4A and 4B, base reel game 400 also includes a bonus wheel feature 432. As discussed herein, bonus wheel feature 432 is utilized, interacted with, and/or displayed during a bonus wheel game (see, FIGS. 8A-8E). Bonus wheel feature 432 may spin and/or provide free spins during the bonus wheel game and award the user of gaming device 104 increased prizes and/or credits, as discussed herein.

During operation, the reel outcome presented during play of the base reel game 400 (e.g., base reel game outcome) corresponds to, presents, represents, and/or is determined from a primary game outcome. For example, the reel outcome (base reel game outcome) may correspond to a primary or underlying Class II game, or the reel outcome may be determined randomly (e.g., in Class III games). Additionally, and as discussed herein, base reel game outcomes and/or conditions of base reel game 400 trigger hold-and-spin bonus game (see, FIGS. 5A-5E), which in turn may trigger a bonus wheel game (see, FIGS. 8A-8E). For example, a base reel game outcome displaying five (5) or more COR symbols 416 within the plurality of reels 402-410 can trigger hold-and-spin bonus game 500. Additionally, or alternatively, each time COR symbols 416 are displayed within the plurality of reels 402-410 of base reel game 400, the credit values associated with each COR symbol 416 can be added together and/or awarded to the player of gaming device 104.

Turning to FIG. 4B, a user interface or screen shot displaying base reel game outcome of the base reel game 400 is shown. In the exemplary embodiment, the plurality of reels 402-410 include eight (8) COR symbols 416. As discussed herein, the inclusion of five (5) or move COR symbols 416 within a single outcome of base reel game 400 results in a hold-and-spin game 500 being triggered (see, FIGS. 5A-5E). Although discussed herein as five (5) or more COR symbols 416 within a single outcome of base reel game 400 triggering hold-and-spin game 500, it is to be understood that any predetermined number of COR symbols 416 displayed during the outcome of base reel game 400 can trigger hold-and-spin game 500.

Visual and/or auditory cues can be presented to the player to identify that hold-and-spin game 500 has been triggered based on the outcome of base reel game 400. In the exemplary embodiments, displayed indications can be provided on display 412 to notify the player that hold-and-spin game 500 has been triggered as a result of the outcome of base reel game 400. For example, base reel game 400 and subsequent display of hold-and-spin game 500 may be provided in conjunction with a change to an overlaid translucent or transparent colored graphic effect around display 412. For instance, in one implementation, display 412 may change to include a color overlay. The color overlay may be displayed for the duration of hold-and-spin game 500 to let a player know they are taking part in the hold-and-spin game. In other implementations, words, symbols, letters, animations, and/or other visual effects (e.g., mascot 434) may be displayed on display 412, and/or auxiliary displays, in addition to and/or alternative to the color overlay.

Referring to FIGS. 5A-5E, exemplary user interfaces or screenshots of a sequence of hold-and-spin bonus game 500 initiated after playing base reel game 400 (see, FIG. 4B) are displayed. The hold-and-spin bonus game 500 is triggered by the primary game outcome (e.g., base reel game outcome) satisfying a hold-and-spin game condition, described in further detail herein. In the example implementation, hold-and-spin bonus game 500 may provide players with various game experiences and/or interactions that can vary from one another and/or provide distinct outcomes and/or awards for the player. In the example implementation, hold-and-spin game 500 may include a predetermined number of spins of the first plurality of reels 402-410. That is, hold-and-spin game 500 also utilizes, includes, and/or facilitates the playing of the game using the plurality of reels 402-410 included within base reel game 400 (see, FIGS. 4A and 4B). In various implementations, hold-and-spin game 500 is not limited to a reel game and may be implemented as another suitable wagering game. However, in the illustrated implementation, hold-and-spin game 500 is a bonus reel game that includes one or more spins and is initiated after play of the base reel game 400.

Hold-and-spin game 500 is triggered in response to a game controller (e.g., the game controller 202) determining that a hold-and-spin game condition is satisfied by the primary or base reel game outcome. For example, the game controller 202 may determine that at least five (5) COR symbols 416 were displayed in the base reel game outcome for base reel game 400. In other exemplary embodiments, such as in Class II bingo game implementations, the hold-and-spin game condition may be a predefined or preselected number of winning bingo patterns included in the bingo game outcome. The game controller 202 may identify and translate the number of winning patterns occurring on the bingo card to triggering hold-and-spin game 500. In various implementations, a hold-and-spin condition may include any suitable trigger condition, such as, for example, generation by RNG 212 of an RNG outcome (e.g., a random number within a range of random numbers) and performing a lookup operation to map the random number to a decision as to whether the hold-and-spin condition is satisfied. The RNG outcome for mapping to the decision as to whether hold-and-spin game condition is satisfied may be generated after each play of a base game (e.g., the base reel game 400), or may itself be randomly generated based on an additionally generated RNG outcome.

In the exemplary embodiment, triggering hold-and-spin game 500 based on the outcome of base reel game 400 (see, FIG. 4B), results in the maintaining of the matrix of symbol positions or matrix of symbol arrangements for the plurality of reels 402-410 shown on display 412. That is, hold-and-spin game 500 continues to display the plurality of reels 402-410 and/or the matrix of symbol positions or arrangements previously displayed during base reel game 400 that triggered hold-and-spin game 500. As shown in FIG. 5A, and as discussed herein, the plurality of reels 402-410 for hold-and-spin game 500 include a 3×3×3×5×5 arrangement, as depicted on display 412, and include nineteen (19) game symbol positions.

Additionally in the exemplary embodiments shown in FIG. 5A, COR symbols 416 previously displayed during base reel game 400 (see, FIG. 4B) remain persistent and/or continue to be displayed within hold-and-spin game 500. That is, COR symbols 416 previously shown in the outcome of base reel game 400 that triggers hold-and-spin game 500 persist and/or are continuously displayed at the beginning of hold-and-spin game 500. Each COR symbol 416 previously displayed during base reel game 400 also maintains its symbol position within the plurality of reels 402-410 when hold-and-spin game 500 is triggered. As discussed herein, COR symbols 416 that persist from base reel game 400 to hold-and-spin game 500 can continuously be displayed through the entirety of hold-and-spin game 500 unless additional conditions are meet.

The remainder of the matrix of symbol positions for the plurality of reels 402-410 are reset upon triggering hold-and-spin game 500. More specifically, symbol positions for the plurality of reels 402-410 occupied and/or including game symbols 414 during base reel game 400 (see, FIG. 4B) are removed, and/or discontinued from being displayed. In the exemplary embodiment shown in FIG. 5A, and prior to “spinning” and/or potentially displaying additional COR symbols 416 within the plurality of reels 402-410 during hold-and-spin game 500, a blank symbol or space 536 (hereafter, “blank symbol 536”) is displayed in the remainder of the matrix of symbol positions not occupied by COR symbols 416. Blank symbol 536 does not include, display, and/or present any credit value that is awarded to the player during hold-and-spin game 500.

In the exemplary embodiment shown in FIG. 5A, hold-and-spin game 500 continues to display wager meter 418, and credit meter 420 on display 412. Furthermore, hold-and-spin game 500 also continues to depict win meter 422 on display 412. As discussed herein, win meter 422 displays a credit and/or monetary value awarded during various outcomes of hold-and-spin game 500. Also shown in FIG. 5A, jackpot bonuses 424-430 continue to be displayed during hold-and-spin game 500. In a non-limiting example, jackpot bonuses 424-430 are displayed during hold-and-spin game 500 as a result of the possibility to award the player any respective jackpot bonus 424-430 during hold-and-spin game 500 if jackpot conditions are met.

Additionally as shown in FIG. 5A, during hold-and-spin game 500, a spin number indicator 538 may be displayed and/or presented to the player of hold-and-spin game 500. Prior to “spinning” the plurality of reels 402-410, spin number indicator 538 can display and/or present a predetermined number of bonus spins for hold-and-spin game 500. In the exemplary embodiment, the predetermined number of bonus spins for hold-and-spin game 500 is three (3)—as displayed in spin number indicator 538.

As discussed herein, the player of hold-and-spin game 500 “spins” the plurality of reels 402-410 to attempt to display additional COR symbols 416 thereon. Additionally as discussed herein, spinning the plurality of reels 402-410 can also result in displaying blank symbols 536. As a result of spinning the plurality of reels 402-410, spin number indicator 538 reduces the number of spins for hold-and-spin game 500 by “1” spin.

FIG. 5B is an exemplary user interface or screen shot of hold-and-spin game 500 after performing a spin of the plurality of reels 402-410. Subsequent to the spin (e.g., spin number indicator 538 reduced by “1”), the plurality of reels 402-410 display and/or present additional COR symbols 416. More specifically, symbol positions “3C,” “4C,” and “5C” for reel 406 display COR symbols 416 including a COR credit value. Blank symbols 536 may remain in each of the rows for reels 402, 404 as a result of the spin as well.

Each spin in which one or more COR symbol 416 lands or is displayed on at least one reel 402-410 of hold-and-spin game 500 resets the spin number indicator 538 back to the predetermined number of spins for hold-and-spin game 500. In the exemplary embodiment shown in FIG. 5C, and with comparison to FIG. 5B, as a result of COR symbols 416 being displayed in reel 406 of hold-and-spin game 500, spin number indicator 538 is reset back to three (3) spins (e.g., predetermined number of bonus spins), prior to the player performing the next spin during hold-and-spin game 500. In another non-limiting example, the number of bonus spins are not reset in response to displaying COR symbols 416 during hold-and-spin game 500. Rather, the player can spin hold-and-spin game 500 the predetermined number of spins (e.g., three spins), before hold-and-spin game 500 ends.

Additionally as shown in FIG. 5C, the credit values corresponding to and/or included with COR symbol 416 newly displayed in reel 406 are added to win meter 422. That is, the total value of each credit value for all COR symbols 416 displayed in reel 406 during hold-and-spin game 500 are added to win meter 422. Credit values are added to win meter 422 each time a newly displayed COR symbol 416 is displayed during hold-and-spin game 500, or alternatively, credit values are only added to win meter 422 when each position of one of the plurality of reels 402-410 includes COR symbol 416. In the non-limiting example, the credit values for each of the three COR symbols 416 are added to win meter 422 as a result of filling each symbol position of reel 406.

In the exemplary embodiment, and as a result of every symbol position of the arrangement or matrix for reel 406 including COR symbol 416 during hold-and-spin game 500, reel 406 is expanded. That is, and during hold-and-spin game 500, when each symbol position of the matrix of symbol positions for any of the plurality of reels 402-410 includes COR symbols 416, that reel 402-410 grows and/or adds an additional row, unless that reel already includes a predetermined maximum number of rows (see, FIG. 5E). In the exemplary shown in FIG. 5C, an additional row is added to reel 406 after each symbol position of the matrix of symbol positions for reel 406 includes COR symbols 416 (see, FIG. 5B). As such, the matrix of symbol positions or arrangement of the plurality of reels 402-410 for hold-and-spin game 500 is 3×3×4×5×5.

Furthermore, and as a result of every symbol position of the arrangement or matrix for reel 406 including COR symbol 416 during hold-and-spin game 500, COR symbols 416 previously included in reel 406 are removed. For example, FIG. 5D is an exemplary user interface or screen shot of hold-and-spin game 500 after performing the spin of the plurality of reels 402-410 that resulted in the expanding and/or growing of reel 406. Prior to any subsequent spins of hold-and-spin game 500, each COR symbol 416 included in any the plurality of reels 402-410 previously including COR symbols 416 in each symbol position are removed, reset, and/or replaced with blank symbols 536. In the exemplary embodiment shown in FIG. 5D, the three (3) COR symbols 416 previously included in reel 406 are replaced with blank symbols 536, such that reel 406 of hold-and-spin game 500 now includes four (4) rows including blank symbols 536. Replacing COR symbols 416 subsequent to the expansion and/or growing of reels 402-410 provides the player increased chances and/or opportunities to receive more credit values associated with distinct COR symbols 416 during additional spins of hold-and-spin game 500.

FIG. 5E is an exemplary user interface or screen shot of hold-and-spin game 500 after additional spins of the plurality of reels 402-410 are performed. In the exemplary embodiment shown in FIG. 5E, and with comparison to FIG. 5D, COR symbols 416 previously displayed and/or persisting in reels 408, 410 (see, FIG. 5D) are replaced with new COR symbols 416 and/or blank symbols 536. As discussed herein, as a result of every symbol position of the arrangement or matrix for reels 408, 410 including COR symbol 416 during hold-and-spin game 500, COR symbols 416 previously included in reels 408, 410 are removed and/or replaced with blank symbols 536 prior to subsequent spins. Additionally, and as discussed herein, prior to removing and/or replacing COR symbols 416, the credit values for each displayed COR symbol 416 in reels 408, 410 are totaled and the total credit value added to win meter 422 (e.g., “1,550”). During subsequent spins of reels 402-410, new or distinct COR symbols 416 are displayed in reels 408, 410, in place of the persisting symbols, as shown in FIG. 5E.

Furthermore, and as discussed herein, when each symbol position of the matrix of symbol positions for any of the plurality of reels 402-410 includes COR symbols 416, that reel 402-410 grows and/or add an additional row, unless that reel already includes a predetermined maximum number of rows. In the exemplary embodiment, the predetermined maximum number of rows for each reel 402-410 is five (5). Because reels 408, 410 already include five rows, reels 408, 410 are not expanded and/or do not grow as a result of every symbol position of the arrangement or matrix for reels 408, 410 including COR symbols 416 during hold-and-spin game 500. Rather, all five COR symbols 416 displayed in each reel 408, 410 are replaced with blank symbols 536, as discussed herein.

The exemplary embodiment shown in FIG. 5E also includes spin number indicator 538 depicting a single (e.g., 1) spin remaining for hold-and-spin game 500. As discussed herein, where the player spins and/or causes the plurality of reels 402-410 to only display blank symbols 536 after the spin, spin number indicator 538 is reduced by one (1). In non-limiting examples, where spin number indicator 538 reaches zero (“0”) spins, hold-and-spin game 500 ends or concludes and base reel game 400 is displayed once again.

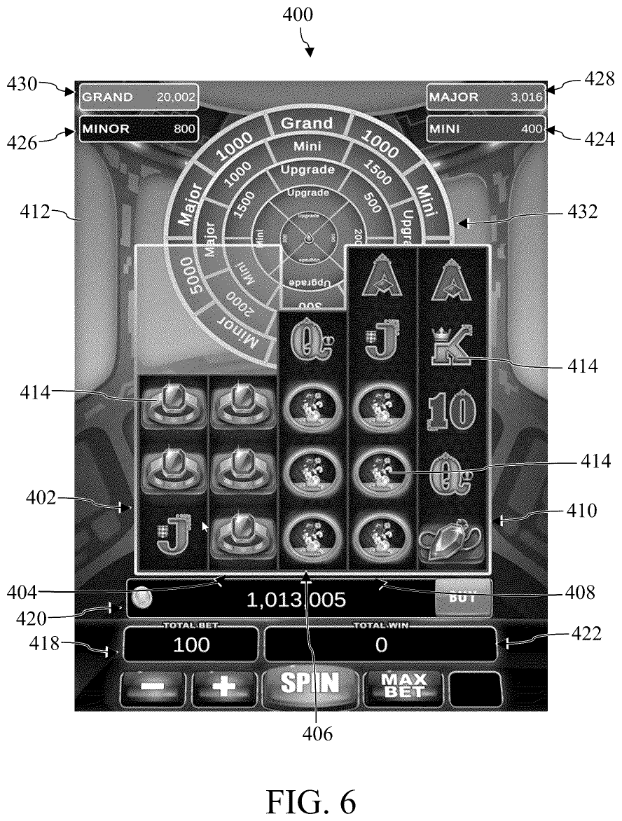

FIG. 6 is an exemplary user interface or screen shot of base reel game 400 following the end of hold-and-spin game 500. As shown in FIG. 6, credit meter 420 has compiled and/or accumulated all winnings or awards that were presented during hold-and-spin game 500. More specifically, credit meter 420 includes the credit values associated with all credit values associated with COR symbols 416 displayed during hold-and-spin game 500 (see, FIG. 5E).

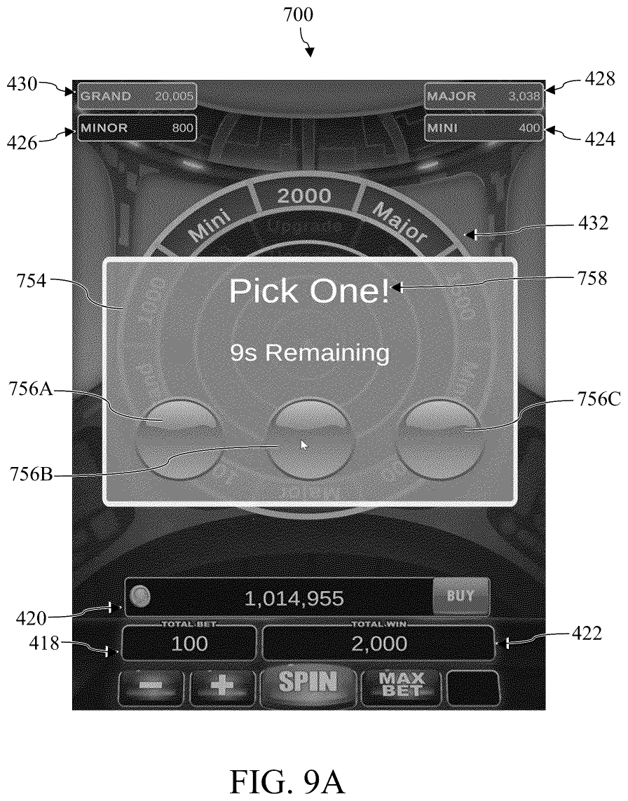

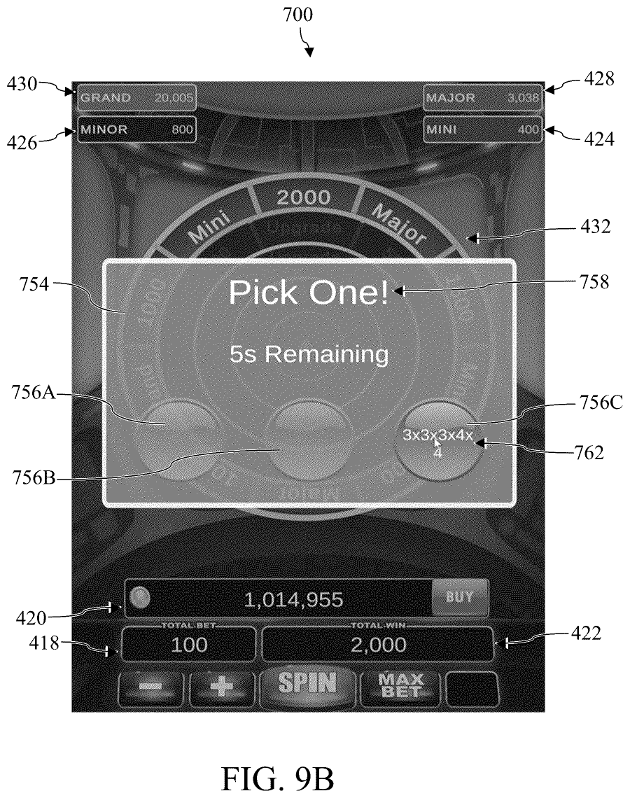

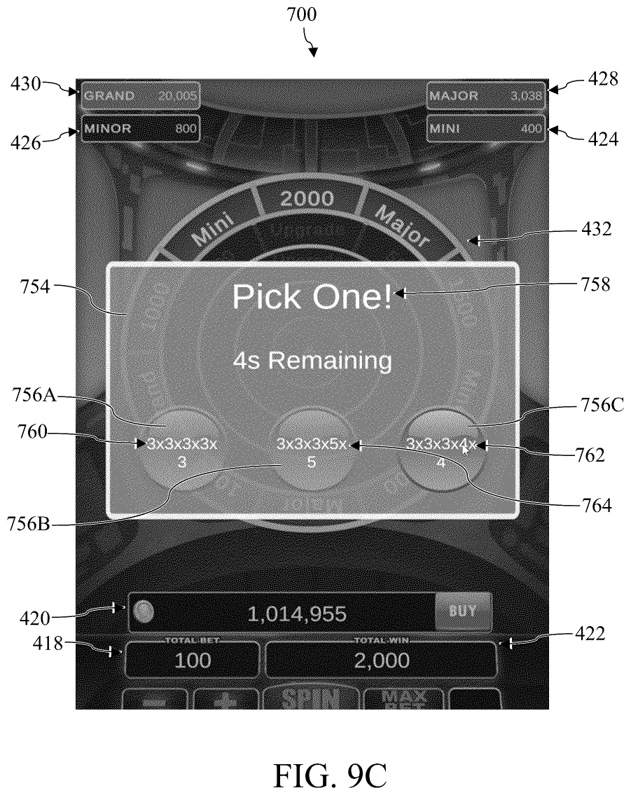

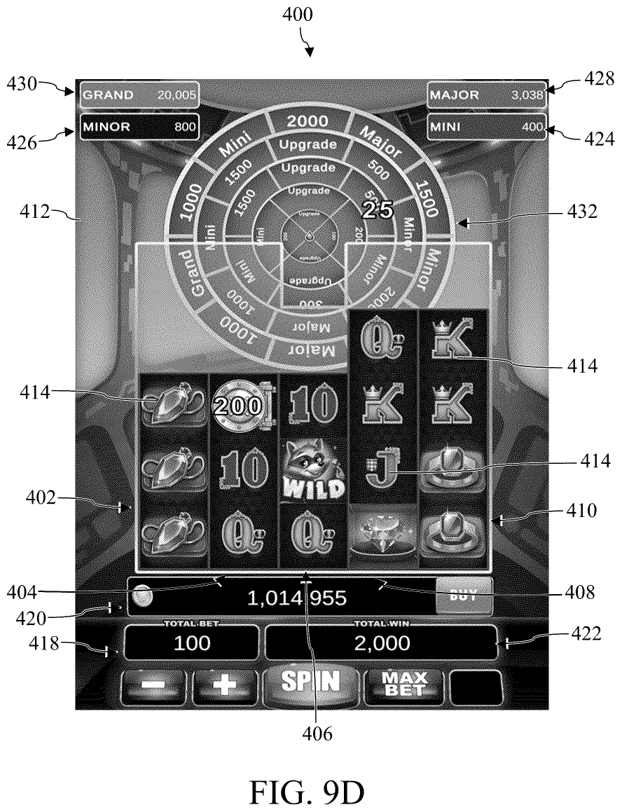

Additionally as shown in FIG. 6, reverting back to base reel game 400 after hold-and-spin game 500 ends results in the plurality of reels 402-410 for base reel game 400 maintaining the matrix and/or arrangement of reels 402-410 achieved during hold-and-spin game 500. That is, the matrix of symbol positions for hold-and-spin game 500, including any gained and/or expanded rows for reels 402-410, are maintained, persist, and/or are included within base reel game 400 after hold-and-spin game 500 ends. For example, and with reference to FIGS. 5A-5E, during hold-and-spin game 500 reel 406 of the plurality of reels gained a row and the matrix of symbol positions or arrangement of the plurality of reels 402-410 is 3×3×4×5×5. As such, when hold-and-spin game 500 ends, base reel game 400 now includes a matrix of symbol positions or arrangement of the plurality of reels 402-410 that is 3×3×4×5×5; as compared to the starting arrangement of 3×3×3×5×5, as shown in FIGS. 4A and 4B. In exemplary embodiments, the matrix of symbol positions or arrangement of the plurality of reels 402-410 may be persistent between hold-and-spin game 500 and base reel game 400, so long as a bonus wheel game 600 is not triggered during hold-and-spin game 500. As discussed herein, bonus wheel game 600 (see, FIGS. 8A-8E) and a subsequent pick bonus game 700 (see, FIGS. 9A-9D) can determine or define the matrix of symbol positions or arrangement of the plurality of reels 402-410 for base reel game 400 after pick bonus game 700.

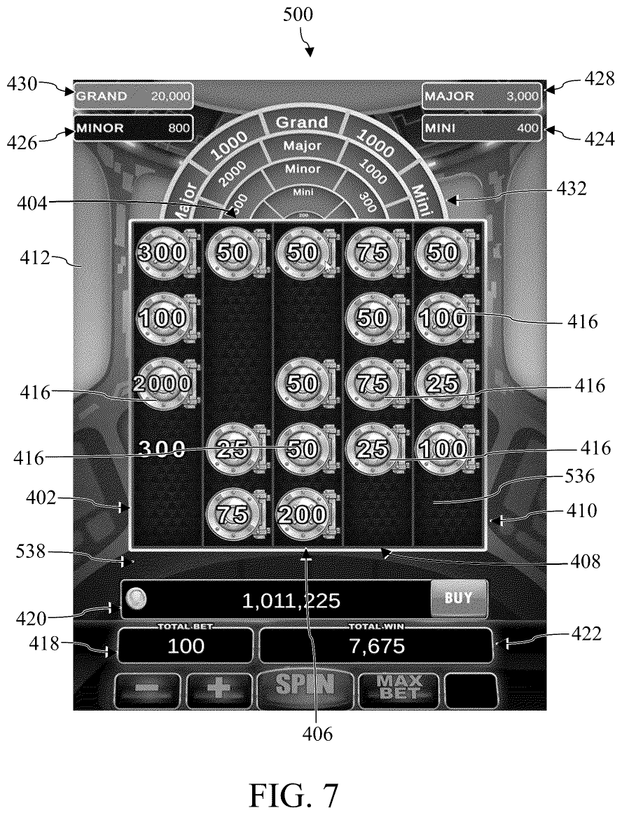

FIG. 7 is another exemplary embodiment of a user interface or screen shot of hold-and-spin game 500 displayed on display 412. More specifically, FIG. 7 is an exemplary embodiment of a user interface or screen shot of a hold-and-spin outcome for hold-and-spin game 500. Distinct from the sequence discussed herein with respect to FIGS. 5A-5E, additional reels 402-410 are grown and/or expanded during hold-and-spin game 500. That is, and as shown in the exemplary embodiment of FIG. 7, each of the plurality of reels 402-410 included in hold-and-spin game 500 are expanded and/or include the predetermined maximum number of row (e.g., 5 rows). As discussed herein, the rows of the plurality of reels 402-410 are grown or expanded 500 as a result of COR symbols 416 being included in every symbol position of the arrangement or matrix for reels 402-410 during the hold-and-spin game 500. As a result, and as shown in FIG. 7, the plurality of reels 402-410 facilitating hold-and-spin game 500 now includes a matrix of symbol positions or arrangement that is 5×5×5×5×5.

As similarly discussed herein with respect to the base reel game outcome, hold-and-spin game outcomes and/or conditions of hold-and-spin game 500 can trigger a bonus wheel game 600 (see, FIGS. 8A-8E). For example, where the final hold-and-spin game outcome for hold-and-spin game 500 displays reel 406 of the plurality of reels 402-410 to include the predetermined maximum number of rows, bonus wheel game 600 is triggered. In the exemplary embodiment shown in FIG. 7, the plurality of reels 402-410, including reel 406, each have been expanded or grown to include five (5) rows (e.g., predetermined maximum number of rows) during hold-and-spin game 500. As a result, once hold-and-spin game 500 ends (e.g., “0” spins in spin number indicator 538), the game play transitions to bonus wheel game 600, before transitioning back to base reel game 400 (see, FIG. 9D).

Although discussed herein as reel 406 triggering bonus wheel game 600, it is to be understood that any of the plurality of reels 402-410 can be designated to trigger bonus wheel game 600. Additionally, although discussed herein as only triggering bonus wheel game 600 when reel 406 includes the predetermined maximum number of rows (e.g., five (5)) during hold-and-spin game 500, it is understood that various other conditions can be met during hold-and-spin game 500 to trigger bonus wheel game 600. For example, any expansion and/or growing of reel 406 during hold-and-spin game 500, regardless of the number of rows, can trigger bonus wheel game 600. Additionally, or alternatively, expanding and/or growing each reel of the plurality of reels 402-410 during hold-and-spin game 500 can trigger bonus wheel game 600, regardless of whether the expanded reels 402-410 include the predetermined maximum number of rows.

Referring to FIGS. 8A-8E, exemplary user interfaces or screenshots of a sequence of bonus wheel game 600 initiated after playing hold-and-spin game 500 (see, FIG. 7) are displayed. As discussed herein, a hold-and-spin game outcome for hold-and-spin game 500 can trigger the displaying and/or playing of bonus wheel game 600. For example, where reel 406 of the plurality of reels 402-410 includes, expands, and/or grows to include the predetermined maximum number of rows (e.g., five rows) during hold-and-spin game 500 (see, FIG. 7), bonus wheel game 600 is triggered at the completion of hold-and-spin game 500.

Bonus wheel game 600 displayed on display 412 includes wheel feature 432. In the non-limiting example, the entirety of bonus wheel feature 432 is displayed in bonus wheel game 600. That is, transitioning from hold-and-spin game 500 (see, FIG. 7) to bonus wheel game 600 includes hiding and/or removing the plurality of reels 402-410 from display 412, such that the entirety of bonus wheel feature 432 is displayed or depicted on display 412. Bonus wheel feature 432 of bonus wheel game 600 includes a plurality of concentric wheels 640A, 640B, 640C, 640D, 640E. In the exemplary embodiment shown in FIGS. 8A-8E, bonus wheel game 600 includes five (5) concentric wheels 640A, 640B, 640C, 640D, 640E. However, it is to be understood that bonus wheel feature 432 of bonus wheel game 600 can include more or less wheels 640. As discussed herein, bonus wheel game 600 starts at the inner most concentric wheel 640A and can move concentrically outward to wheels 640B-640E as bonus wheel game 600 progresses.

The plurality of concentric wheels 640A-640E include a plurality of wedges 642. More specifically, each of the plurality of concentric wheels 640A-640E for wheel feature 432 may be formed and/or divided into a plurality of wedges 642 disposed circumferentially about a center reference point. In the non-limiting example shown, each wedge 642 for each concentric wheel 640A-640E is sized equally. However, in other non-limiting examples (not shown), the plurality of wedges 642 may include distinct sizes with respect to one another. Each wedge of the plurality of wedges 642 depict a credit value 644, an upgrade feature 646, or a jackpot feature 648. The credit value 644 depicted, displayed, and/or associated with each wedge of the plurality of wedges 642 represents a predetermined credit value that can provide additional award credits to the player during the bonus wheel game 600, as discussed herein. Additionally, upgrade feature 646 depicted, displayed, and/or associated with wedge(s) 642 can include a gameplay feature in which bonus wheel game 600 will move to a concentrically adjacent and outward wheel 640A-640E as a result of “landing” on upgrade feature 646. As discussed herein, the credit values, chances of winning, and/or jackpot values increase with each wheel 640B-640E positioned concentrically outward from the inner most wheel 640A. Jackpot feature 648 of wedge(s) 642 are associated with and/or correspond to an indicated jackpot bonus 424-430 shown in display 412.

Bonus wheel game 600 also includes at least one pointer 650. Pointer 650 is positioned adjacent to wheel feature 432. More specifically, a central pointer 650, as shown in FIGS. 8A-8E, is positioned central to and/or at a center of each concentric wheel 640A-640E of bonus wheel feature 432. During the spin and/or game play of bonus wheel game 600, pointer 650 visually identifies the wedge 642 of playable wheel 640A-640E that has been selected and/or awarded to the player. That is, once concentric wheel 640A-640E of wheel feature 432 stops spinning during bonus wheel game 600, pointer 650 identifies and/or indicates the wedge 642, and associated credit value 644, upgrade feature 646 or jackpot feature 648, that is awarded to the player during that particular spin. As discussed herein, the credit value 644, upgrade feature 646 or jackpot feature 648 identified by pointer 650 is referred to as the bonus wheel game outcome. As shown in FIG. 8A, pointer 436 is formed and/or depicted as a substantially triangular shape. However, it should be understood that pointer 650 can be formed as any shape, symbol, figure, and/or graphic that can readily identify wedges 642 of wheel feature 432 during bonus wheel game 600.

Additionally as shown in FIG. 8A, bonus wheel game 600 also includes or depicts a bonus wheel game spin indicator 652. Prior to “spinning” the wheels 640A-640E of wheel feature 432, bonus wheel game spin indicator 652 can display and/or present a number of spins for bonus wheel game 600. In the exemplary embodiment, the number of spins for bonus wheel game 600 is dependent, based on, and/or defined by the number of reels 402-410 included in hold-and-spin game 500 that include the predetermined maximum number of rows (e.g., five (5) rows) at the end of hold-and-spin game 500 and/or in the hold-and-spin game final outcome. For example, and briefly returning to FIG. 7, each of the plurality of reels 402-410 included in hold-and-spin game 500 include five (5) rows (e.g., predetermined maximum). As such, and as shown in FIG. 8A, bonus wheel game spin indicator 652 includes five “5” spins at the start of bonus wheel game 600. In other non-limiting examples, the number of spins for bonus wheel game 600, as indicated by bonus wheel game spin indicator 652, is constant and/or predefined. For example, each time bonus wheel game 600 is triggered, a player gets three (3) spins for bonus wheel game 600.

FIG. 8A is an exemplary user interface or screenshot of bonus wheel game 600 prior to the first spin and/or first bonus wheel game outcome. Additionally, FIG. 8B is an exemplary user interface or screenshot of bonus wheel game 600 that shows an exemplary bonus wheel game outcome for bonus wheel game 600. More specifically, FIG. 8B shows a user interface or screen shot depicting the bonus wheel game outcome for a first spin for bonus wheel game 600. In the non-limiting example, bonus wheel game outcome awards the player 100 credits. That is, when first wheel 640A of wheel feature 432 stops spinning, pointer 650 of bonus wheel game 600 identifies wedge 642 of wheel 640A that includes credit value 644 equal to or depicting “100” credits. The awarded credits identified in wheel 640A are subsequently added to win meter 422. In the non-limiting example, the spin value included in bonus wheel game spin indicator 652 is also reduced by one (1) as result of the first spin being performed.

FIG. 8C is an exemplary user interface or screen shot that shows a distinct or subsequent bonus wheel game outcome for bonus wheel game 600. For example, display 412 shows a distinct or subsequent bonus wheel game outcome for a subsequent or fifth spin for bonus wheel game 600. As a result of being the fifth spin of bonus wheel game 600, bonus wheel game spin indicator 652 depicts a zero (“0”) value for remaining spins. As shown, bonus wheel game outcome may award the player the upgrade feature 646. More specifically, pointer 650 of bonus wheel game 600 identifies wedge 642 of wheel 640A that includes upgrade feature 646. As discussed herein, upgrade feature 646 provides the player with the opportunity to respin on a wheel 640B-640E concentrically adjacent to and outward from the previously spun wheel 640A-640D.

FIG. 8D is an exemplary user interface or screen shot that shows bonus wheel game 600 after landing on upgrade feature 646, as shown in FIG. 8C. In the exemplary embodiment, second wheel 640B, concentrically adjacent to and outward from first wheel 640A, is subsequently highlighted and/or is utilized for the subsequent spin during bonus wheel game 600 as a result of previously landing on upgrade feature 646 included in wheel 640A. Additionally as shown, and as a result of previously landing on upgrade feature 646 included in wheel 640A on the final or fifth spin of bonus wheel game 600, the player of bonus wheel game 600 may regain their spin. For example, bonus wheel game spin indicator 652, as shown in FIG. 8D, includes a “1” in the spin value, indicated to the player that after upgrading, they player can respin the newly identified wheel 640B during bonus wheel game 600.

FIG. 8E is an exemplary user interface or screen shot that shows a distinct or subsequent bonus wheel game outcome for bonus wheel game 600. For example, display 412 shows a distinct or subsequent bonus wheel game outcome for a subsequent spin for bonus wheel game 600. In the exemplary embodiment, wheel feature 432 is upgraded such that the player's final spin of bonus wheel game 600 is conducted on the fifth or outermost concentric wheel 640E. As discussed herein, as the concentrically wheels 640A-640E move concentrically outward from the first or inner most wheel 640A, the prize or credit values increase and/or the number of wedges 642 including in wheels 640A-640E increases. For example, first wheel 640A includes four (4) wedges 642 with the highest credit value 644 of “200,” while the fifth wheel 640E includes ten (10) wedges 642 including credit values 644 as high as “5000” and jackpot features 648 associated with and/or corresponding to grand jackpot bonus 430.

FIG. 8E shows a user interface or screen shot depicting the bonus wheel game outcome for a final spin for bonus wheel game 600. In the non-limiting example, bonus wheel game outcome awards the player 2000 credits. That is, when fifth wheel 640E of wheel feature 432 stops spinning, pointer 650 of bonus wheel game 600 identifies wedge 642 of wheel 640E that includes credit value 644 equal to or depicting “2000” credits. The awarded credits identified in wheel 640E are subsequently added to win meter 422. In the non-limiting example, the spin value included in bonus wheel game spin indicator 652 is also equal to zero “0” indicated the end of bonus wheel game 600.

The completion or end of bonus wheel game 600 also triggers pick bonus game 700. That is, upon completing the defined number of spins for bonus wheel game 600, pick bonus game 700 is triggered for the player. FIGS. 9A-9D are exemplary user interfaces or screenshots of a sequence of pick bonus game 700 initiated and/or triggered after completing bonus wheel game 600. As discussed herein, the final bonus wheel game outcome for bonus wheel game 600 can trigger the displaying and/or playing of pick bonus game 700.

FIG. 9A is an exemplary user interface or screen shot after pick bonus game 700 has been triggered. In the exemplary embodiment, display 412 shown in FIG. 9A provides a bonus game notification and/or animation 754 indicating that pick bonus game 700 has been triggered. In the example, pick bonus game 700 may replace and/or overlap wheel feature 432 once triggered. Additionally, FIG. 9A depicts pick bonus game 700 prior to a player selection. Pick bonus game 700 includes a plurality of selectable pick game symbols 756 that are presented to the player on display 412, and more specifically, within pick bonus game notification 754. In the non-limiting example, three selectable pick game symbols 756A, 756B, 756C are included in pick bonus game 700. In other non-limiting examples, the plurality of selectable pick game symbols 756 can include more or less than three (3) symbols and/or may continuously move in a random pattern. Additionally, as shown, pick bonus game 700 can include instructions or a player prompt 758 instructing the player to select one of the plurality of selectable pick game symbols 756A, 756B, 756C displayed on display 412.

In exemplary embodiments, each of the plurality of selectable pick game symbols 756 are associated with a base reel game matrix for the plurality of expandable reels 402-410 included in base reel game 400. That is, and as discussed herein, each of the plurality of selectable pick game symbols 756A, 756B, 756C displayed during pick bonus game 700 are associated with, correspond to, and/or define a base reel game matrix or arrangement for the plurality of expandable reels 402-410 included in a subsequent base reel game 400. However, prior to picking or selecting one of the plurality of selectable pick game symbols 756A, 756B, 756C, the associated base reel game matrix or arrangement for the plurality of expandable reels 402-410 for each selectable pick game symbols 756A, 756B, 756C are not displayed to the player, as shown in FIG. 9A.

Prior to the selection of one of the plurality of selectable pick game symbols 756A, 756B, 756C, during pick bonus game 700, the base reel game matrix or arrangement for the plurality of expandable reels 402-410 are generated for and associated with each of the plurality of selectable pick game symbols 756A, 756B, 756C. In exemplary embodiments, each of the base reel game matrix or arrangements are distinct from one another. More specifically, and in the instance where pick bonus game 700 includes three (3) selectable pick game symbols 756A, 756B, 756C, the base reel game matrix for the plurality of expandable reels 402-410 associated with each of the plurality of selectable pick game symbols 756A, 756B, 756C includes three distinct base game matrices 760, 762, 764 (see, FIG. 9C). A first base game matrix 760 including a first arrangement of the plurality of reels 402-410, and a second base game matrix 762 (see, FIG. 9C) includes a second arrangement of the plurality of reels 402-410 that is larger than and/or includes at least one reel 402-410 having more rows than those included in the first arrangement of first base game matrix 760. Additionally, a third base game matrix 764 (see, FIG. 9C) includes a third arrangement of the plurality of reels 402-410 that is larger than and/or includes at least one reel 402-410 having more rows than those included in the second arrangement of second base game matrix 762.

Briefly turning to FIG. 9C, first base game matrix 760 is associated and/or corresponds with selectable pick game symbol 756A and includes the first arrangement for the plurality of reels 402-410 that is configured as a 3×3×3×3×3 matrix. Second base game matrix 762 is associated and/or corresponds with selectable pick game symbol 756C and includes the second arrangement for the plurality of reels 402-410 that is configured as a 3×3×3×4×4 matrix. Finally, third base game matrix 764 is associated and/or corresponds with selectable pick game symbol 756B and includes the third arrangement for the plurality of reels 402-410 that is configured as a 3×3×3×5×5 matrix. It is to be understood that the matrix and/or arrangements discussed herein are non-limiting, and each base game matrix 760, 762, 764 can include any combination and/or matrix arrangement for the plurality of reels 402-410, as discussed herein.

FIG. 9B is an exemplary user interface or screen shot after one of the plurality of selectable pick game symbols 756A, 756B, 756C is selected by the player. In the non-limiting example, selectable pick game symbol 756C is selected and/or picked by the player. As a result, second base game matrix 762 including the second arrangement for the plurality of reels 402-410 is shown on display device 412. That is, and as discussed herein, the second base game matrix 762 assigned and/or associated with selectable pick game symbol 756C. As such, when the player selects or picks selectable pick game symbol 756C during pick bonus game 700, display 412 displays or visually depicts second base game matrix 762 for the plurality of reels 402-410 associated with selectable pick game symbol 756C. The provided second base game matrix 762 and second arrangement (e.g., “3×3×3×4×4”) indicates to the player that the next base reel game 400 played after pick bonus game 700 ends will include the plurality of reels 402-410 having a 3×3×3×4×4 matrix of symbol positions or arrangement (see, FIG. 9D), as discussed herein.

In exemplary embodiments each generated base reel game matrix 760, 762, 764 is assigned to one of the plurality of selectable pick game symbols 756A, 756B, 756C prior to the selection of the pick game symbols 756A, 756B, 756C. As a result, the selection of the corresponding base reel game matrix 760, 762, 764 during pick bonus game 700 is random and/or equally weighted for the player. In another non-limiting example, the generated base reel game matrices 760, 762, 764 for the plurality of expandable reels 402-410 are biased and/or weighted prior to the selection of the selectable pick game symbols 756A, 756B, 756C. In the non-limiting example where the generated base reel game matrices 760, 762, 764 are biased or weighted, the base reel game matrices 760, 762, 764 are not assigned to corresponding the selectable pick game symbols 756A, 756B, 756C until after the player selects one of the selectable pick game symbols 756A, 756B, 756C. Rather, prior to the selection of one of the plurality of selectable pick game symbols 756A, 756B, 756C, one of the generated base reel game matrices 760, 762, 764 is selected and/or determined based on, at least in part, a weighted factor and/or a lookup or weighted tables (e.g., FIG. 2A). Once selected using the weighted factors and/or lookup/weighted tables, the selected base reel game matrix 760, 762, 764 is displayed in whichever selectable pick game symbols 756A, 756B, 756C the player selects during pick bonus game 700.

FIG. 9C is an exemplary user interface or screen shot after one of the plurality of selectable pick game symbols 756A, 756B, 756C is selected by the player, and prior to redisplaying base reel game 400 including the selected second base reel game matrix 762 for the plurality of reels 402-410. In the exemplary embodiment, unselected reel game matrices 760, 764 associated within selectable pick game symbols 756A, 756B, respectively, are displayed on display 412. That is, and to increase player excitement, in response to one of the plurality of selectable pick game symbols 756A, 756B, 756C being selected, display 412 displays base reel game matrices 760, 764 for the plurality of expandable reels 402-410 associated with the unselected pick game symbols 756A, 756B.

FIG. 9D is an exemplary user interface or screen shot after the conclusion or end of pick bonus game 700. Specifically, after the player selects one of the plurality of selectable pick game symbols 756A, 756B, 756C to identify a base reel game matrix 760, 762, 764, display 412 redisplays base reel game 400. However, the base reel game 400 redisplayed immediately after the end of pick bonus game 700 includes the plurality of expandable reels 402-410 having a matrix or arrangement similar to that of the identified base reel game matrix 760, 762, 764. For example, and as shown in FIG. 9D, base reel game 400 includes the plurality of reels 402-410 having a matrix of symbol positions or arrangement equal to 3×3×3×4×4. The 3×3×3×4×4 arrangement displayed in base reel game 400 corresponds to the second arrangement of second base reel game matrix 762 for the plurality of reels 402-410 selected and/or identified during pick bonus game 700, and/or associated with selected, pick game symbol 756C (see, FIGS. 9B and 9C).

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the implementations described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc - read only memory (CD-ROM), a magneto-optical disk (MOD), and/or a digital versatile disc (DVD) may also be used. Also, in the implementations described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary implementation, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g. an EEPROM). Further, different parts of the computer software can be executed by different devices, such as, for example, in a client-server relationship. Persons skilled in the art will appreciate that computer software provides a series of instructions executable by the processor.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
at least one memory for storing instructions; and
a game controller in communication with the at least one memory, the game controller including at least one processor, when the instructions are executed by the at least one processor, the at least one processor configured to:
cause to be displayed on a display device a hold-and-spin game triggered by an outcome of a base reel game, the hold-and-spin game and the base reel game including a plurality of expandable reels;
determine that an outcome of the hold-and-spin game triggers a bonus wheel game, the bonus wheel game including a plurality of rotatable bonus wheels; and
in response to the bonus wheel game concluding, cause to be displayed on the display device a pick bonus game, the pick bonus game including a plurality of selectable pick game symbols,
wherein each of the plurality of selectable pick game symbols are associated with a base reel game matrix for the plurality of expandable reels.

2. The electronic gaming system of claim 1, wherein the instructions stored in the memory, when executed by the at least one processor, further cause the at least one processor to:
in response to one of the plurality of selectable pick game symbols being selected, cause to be displayed on the display device the base reel game matrix for the plurality of expandable reels associated with the selected pick game symbol.

3. The electronic gaming system of claim 2, wherein the instructions stored in the memory, when executed by the at least one processor, further cause the at least one processor to:
subsequent to the selection of one of the plurality of selectable pick game symbols, cause to be displayed on the display device the base reel game including the base reel game matrix for the plurality of expandable reels associated with the selected pick game symbol.

4. The electronic gaming system of claim 2, wherein the instructions stored in the memory, when executed by the at least one processor, further cause the at least one processor to:
generate the base reel game matrix for the plurality of expandable reels associated prior to the selection of the pick game symbol; and
one of:
assign each generated base reel game matrix for the plurality of expandable reels to one of the plurality of selectable pick game symbols prior to the selection of the pick game symbols, or
bias one of the generated base reel game matrix for the plurality of expandable reels prior to the selection of the pick game symbols,
wherein one of the assigned base reel game matrix or the biased base reel game matrix is caused to be displayed in response to one of the plurality of selectable pick game symbols being selected.

5. The electronic gaming system of claim 2, wherein the instructions stored in the memory, when executed by the at least one processor, further cause the at least one processor to:
in response to one of the plurality of selectable pick game symbols being selected, cause to be displayed on the display device the base reel game matrix for the plurality of expandable reels associated with unselected pick game symbols.

6. The electronic gaming system of claim 1, wherein the base reel game matrix for the plurality of expandable reels associated with each of the plurality of selectable pick game symbols further includes:
a first base reel game matrix including a first arrangement of the plurality of expandable reels;
a second base reel game matrix including a second arrangement of the plurality of expandable reels, the second arrangement being larger than the first arrangement of the first base reel game matrix; and
a third base reel game matrix including a third arrangement of the plurality of expandable reels, the third arrangement being larger than the second arrangement of the second base reel game matrix.

7. The electronic gaming system of claim 1, wherein the instructions stored in the memory, when executed by the at least one processor, further cause the at least one processor to:
in response to determining that the outcome of the hold-and-spin game does not triggers the bonus wheel game, cause to be displayed on the display device the base reel game.

8. A method of electronic gaming implemented on an electronic gaming machine, the method comprising:
causing to be displayed on a display device a hold-and-spin game triggered by an outcome of a base reel game, the hold-and-spin game and the base reel game including a plurality of expandable reels;
determining that an outcome of the hold-and-spin game triggers a bonus wheel game, the bonus wheel game including a plurality of rotatable bonus wheels; and
in response to the bonus wheel game concluding, causing to be displayed on the display device a pick bonus game, the pick bonus game including a plurality of selectable pick game symbols,
wherein each of the plurality of selectable pick game symbols are associated with a base reel game matrix for the plurality of expandable reels.

9. The method of claim 8, further comprising:
in response to one of the plurality of selectable pick game symbols being selected, causing to be displayed on the display device the base reel game matrix for the plurality of expandable reels associated with the selected pick game symbol.

10. The method of claim 9, further comprising:
subsequent to the selection of one of the plurality of selectable pick game symbols, causing to be displayed on the display device the base reel game including the base reel game matrix for the plurality of expandable reels associated with the selected pick game symbol.

11. The method of claim 9, further comprising:
generating the base reel game matrix for the plurality of expandable reels associated prior to the selection of the pick game symbol; and
one of:
assigning each generated base reel game matrix for the plurality of expandable reels to one of the plurality of selectable pick game symbols prior to the selection of the pick game symbols, or
biasing one of the generated base reel game matrix for the plurality of expandable reels prior to the selection of the pick game symbols,
wherein one of the assigned base reel game matrix or the biased base reel game matrix is caused to be displayed in response to one of the plurality of selectable pick game symbols being selected.

12. The method of claim 9, further comprising:
in response to one of the plurality of selectable pick game symbols being selected, causing to be displayed on the display device the base reel game matrix for the plurality of expandable reels associated with unselected pick game symbols.

13. The method of claim 8, wherein the base reel game matrix for the plurality of expandable reels associated with each of the plurality of selectable pick game symbols further includes:
a first base reel game matrix including a first arrangement of the plurality of expandable reels;
a second base reel game matrix including a second arrangement of the plurality of expandable reels, the second arrangement being larger than the first arrangement of the first base reel game matrix; and
a third base reel game matrix including a third arrangement of the plurality of expandable reels, the third arrangement being larger than the second arrangement of the second base reel game matrix.

14. The method of claim 8, further comprising:
in response to determining that the outcome of the hold-and-spin game does not triggers the bonus wheel game, causing to be displayed on the display device the base reel game.

15. A non-transitory computer-readable storage medium with instructions stored thereon that, in response to execution by at least one processor, cause the at least one processor to:
cause to be displayed on a display device a hold-and-spin game triggered by an outcome of a base reel game, the hold-and-spin game and the base reel game including a plurality of expandable reels;
determine that an outcome of the hold-and-spin game triggers a bonus wheel game, the bonus wheel game including a plurality of rotatable bonus wheels; and
in response to the bonus wheel game concluding, cause to be displayed on the display device a pick bonus game, the pick bonus game including a plurality of selectable pick game symbols,
wherein each of the plurality of selectable pick game symbols are associated with a base reel game matrix for the plurality of expandable reels.

16. The non-transitory computer-readable storage medium of claim 15, wherein the instructions, when executed, cause the at least one processor to:
in response to one of the plurality of selectable pick game symbols being selected, cause to be displayed on the display device the base reel game matrix for the plurality of expandable reels associated with the selected pick game symbol.

17. The non-transitory computer-readable storage medium of claim 16, wherein the instructions, when executed, cause the at least one processor to:
subsequent to the selection of one of the plurality of selectable pick game symbols, cause to be displayed on the display device the base reel game including the base reel game matrix for the plurality of expandable reels associated with the selected pick game symbol.

18. The non-transitory computer-readable storage medium of claim 16, wherein the instructions, when executed, cause the at least one processor to:
generate the base reel game matrix for the plurality of expandable reels associated prior to the selection of the pick game symbol; and
one of:
assign each generated base reel game matrix for the plurality of expandable reels to one of the plurality of selectable pick game symbols prior to the selection of the pick game symbols, or
bias one of the generated base reel game matrix for the plurality of expandable reels prior to the selection of the pick game symbols,
wherein one of the assigned base reel game matrix or the biased base reel game matrix is caused to be displayed in response to one of the plurality of selectable pick game symbols being selected.

19. The non-transitory computer-readable storage medium of claim 16, wherein the instructions, when executed, cause the at least one processor to:
in response to one of the plurality of selectable pick game symbols being selected, cause to be displayed on the display device the base reel game matrix for the plurality of expandable reels associated with unselected pick game symbols.

20. The non-transitory computer-readable storage medium of claim 15, wherein the instructions, when executed, cause the at least one processor to:
in response to determining that the outcome of the hold-and-spin game does not triggers the bonus wheel game, cause to be displayed on the display device the base reel game.
